(19) United States
(12) Patent Application Publication
(10) Pub. No.: US 2018/0337517 A1
(43) Pub. Date: Nov. 22, 2018

(54) SENSING LAMP AND DRIVING METHOD THEREOF

(71) Applicants: BOE TECHNOLOGY GROUP CO., LTD., Beijing (CN); BOE OPTICAL SCIENCE AND TECHNOLOGY CO., LTD., Suzhou, Jiangsu (CN)

(72) Inventor: Qianglong HU, Beijing (CN)

(21) Appl. No.: 15/504,147

(22) PCT Filed: Jul. 7, 2016
(86) PCT No.: PCT/CN2016/089103

§ 371 Date: Feb. 15, 2017

(30) Foreign Application Priority Data
Jan. 4, 2016 (CN) 201610003202.0

(51) Int. Cl. H02B 11/02

(52) U.S. Cl. CPC H02B 11/02

(57) ABSTRACT

A sensing lamp and a driving method thereof are disclosed. The sensing lamp includes a light source (101, 207) and a sense-drive circuit for providing a driving signal to the light source; the sense-drive circuit includes a sensing module (102, 205), a sensing power supply module (204) and an output module (206), the sensing power supply module (204) is connected with the sensing module (102, 205), the sensing module (102, 205) is connected with the output module (206), and the output module (206) is connected with the light source (101, 207); the sensing module (102, 205) is configured to sense a trigger signal and generate a control signal according to the trigger signal; the output module (206) is configured to provide a driving signal to the light source (101, 207) according to the control signal; and the sensing power supply module (204) is configured to supply the sensing module (102, 205) with electrical power.

### CROSS-REFERENCE TO RELATED APPLICATIONS

This application claims the right of priority based on China Paten Application No. 201610003202.0, filed on Jan. 4, 2016, the entire contents of which are incorporated herein by reference.

### TECHNICAL FIELD

Embodiments of the present disclosure relate to the field of electronic technology, particularly to a sensing lamp and a driving method thereof.

### BACKGROUND

Sensing lamps such as microwave sensing lamps are lamps which can be triggered and turned on by means of external physical conditions. At present, sensing lamps have become commonly used electronic products in daily life, especially in public places. Places such as underground garage, staircase walkways, automated factories, warehouses, elevators, and balconies need to maintain 24-hour lighting, but most of the time these places are empty with no one there. It may result in energy waste if the lamps are always operated at high brightness. Sensing lamps can maintain slight-bright state or be turned off when the place is empty, and be switched to full-bright state when someone is around by sensing physical parameters of a human body quickly, so as to save energy.

Driving control circuits for sensing lamps in the related art are mostly achieved by switching power supplies with complex working principle, higher cost and lower efficiency.

### SUMMARY

In view of the above, embodiments of the present disclosure provide a sensing lamp and a driving method thereof. The sensing lamp includes a light source and a sense-drive circuit configured to provide a driving signal to the light source; the sense-drive circuit includes a sensing module, a sensing power supply module and an output module; the sensing power supply module is connected with the sensing module, the sensing module is connected with the output module, and the output module is connected with the light source; the sensing module is configured to sense a trigger signal and generate a control signal according to the trigger signal; the output module is configured to provide a driving signal to the light source according to the control signal; and the sensing power supply module is configured to supply the sensing module with electrical power. The sensing lamp can achieve higher efficiency and stable operation. The driving method can drive the sensing lamp to illuminate under the trigger of the sensing signal.

Based on the above-mentioned objective, the present disclosure provides a sensing lamp including a light source and a sense-drive circuit configured to provide a driving signal to the light source; wherein the sense-drive circuit includes a sensing module, a sensing power supply module and an output module; the sensing power supply module is connected with the sensing module, the sensing module is connected with the output module, and the output module is connected with the light source; the sensing module is configured to sense a trigger signal and generate a control signal according to the trigger signal; the output module is configured to provide a driving signal to the light source according to the control signal; and the sensing power supply module is configured to supply the sensing module with electrical power.

Optionally, the sensing power supply module includes a first capacitor, a voltage regulator tube and a first resistor; the first capacitor and the voltage regulator tube are disposed in parallel; the sensing module includes a positive voltage terminal, a negative voltage terminal and a reference voltage terminal, the negative voltage terminal is connected with a grounding terminal; the first resistor is connected with the light source; a parallel circuit of the first capacitor and the voltage regulator tube has one end connected with the positive voltage terminal of the sensing module and the first resistor, respectively, and the other end connected with the grounding terminal.

Optionally, the first resistor includes four resistors connected in series.

Optionally, the sense-drive circuit further includes a protection module; the protection module is disposed between the light source and the sense-drive circuit in series therewith, and configured to protect the sense-drive circuit; and the protection module includes a first diode and a second capacitor disposed in series with the first diode; the first diode is connected with the light source, and the second capacitor is connected with the sensing power supply module.

Optionally, the output module includes a metal-oxide-semiconductor field effect transistor (MOSFET); a first electrode and a second electrode of the MOSFET are connected with the light source, and a gate electrode of the MOSFET is connected with the reference voltage terminal of the sensing module.

Optionally, the output module further includes a third resistor; the third resistor is disposed between the reference voltage terminal of the sensing module and the gate electrode of the MOSFET.

Optionally, the output module further includes a first protection capacitor, wherein the first protection capacitor is disposed in parallel with the MOSFET.

Optionally, the light source includes a light-emitting diode (LED).

Optionally, the sense-drive circuit further includes a constant current module configured to stabilize the driving signal provided by the output module; the constant current module includes a first constant current chip and a second constant current chip; each of the first constant current chip and the second constant current chip has a first end connected with the light source, a second end connected with a grounding terminal, and a third end connected with a first electrode or a second electrode of the MOSFET.

Optionally, the output module further includes a fourth resistor and a fifth resistor; the fourth resistor is disposed between the first electrode of the MOSFET and the third end of the first constant current chip; and the fifth resistor is disposed between the second electrode of the MOSFET and the third end of the second constant current chip.

Optionally, the sense-drive circuit further includes a rectifier filter module; the rectifier filter module includes a rectifier bridge, the rectifier bridge includes four diodes and is provided with four connection ports, wherein a first connection port and a second connection port are respectively connected with a positive terminal and a negative terminal of a power supply, and a third connection port and a fourth connection port are respectively connected with the light source and a grounding terminal.

Optionally, the rectifier filter module further includes a sixth resistor, the sixth resistor includes at least one resistor; one end of the sixth resistor is connected with a second end of the light source, and the other end of the sixth resistor is connected with the grounding terminal.

Optionally, the sensing lamp further includes a second protection capacitor disposed in parallel with the light source.

Optionally, the sensing lamp further includes a glass tube in which the light source is disposed and a plug provided at both ends of the glass tube, wherein the sensing module is connected with the plug.

Optionally, the sensing lamp further includes a flexible printed circuit board (FPCB), wherein the light source is disposed on the FPCB, and the FPCB is attached on an inner side of the glass tube.

Optionally, the light source includes a plurality of light-emitting diodes (LEDs), and the LEDs are evenly distributed on the FPCB.

Optionally, an interior of the glass tube is provided with diffusion powder.

Optionally, the trigger signal is a microwave signal.

Optionally, the sensing module is a microwave sensing module configured to sense a microwave of a human body or an animal body.

On the other hand, the present disclosure provides a driving method of a sensing lamp, including: sensing a microwave signal in an environment; and upon sensing the microwave signal, sending an electric signal to a light source so that a brightness of the light source is switched from a first brightness to a second brightness, wherein the second brightness is higher than the first brightness.

The present disclosure provides a sensing lamp including a light source and a sense-drive circuit configured to provide a driving signal to the light source, wherein the sense-drive circuit includes a sensing module, a sensing power supply module and an output module, the sensing power supply module is connected with the sensing module, the sensing module is connected with the output module, and the output module is connected with the light source; the sensing module is configured to sense a trigger signal and generate a control signal according to the trigger signal; the output module is configured to provide a driving signal to the light source according to the control signal; and the sensing power supply module is configured to supply the sensing module with electrical power. The sensing lamp can achieve induction lighting under the trigger signal, and allows a relatively stable working state.

### BRIEF DESCRIPTION OF THE DRAWINGS

In order to clearly illustrate the technical solution of the embodiments of the present application, the drawings of the embodiments will be briefly described in the following; it is obvious that the described drawings are only related to some embodiments of the present application. It will be apparent to one of ordinary skill in the art that other drawings may be obtained without departing from the inventive effort of the accompanying drawings. The following drawings are not intentionally scaled in actual size, with emphasis on illustrating the gist of the present application only.

FIG. 1 is a schematic view of a sense-drive circuit of a sensing lamp provided by an embodiment of the present disclosure;

FIG. 2 is a schematic view of a sense-drive circuit of the sensing lamp in a modular structure provided by an embodiment of the present disclosure;

FIG. 3 is a schematically exploded view of a housing of the sensing lamp provided by an embodiment of the present disclosure; and

FIG. 4 is a schematic view illustrating an external structure of the sensing lamp provided by an embodiment of the present disclosure.

### DETAILED DESCRIPTION

In order to more clearly and fully illustrate the technical solutions of the present disclosure, the drawings which are required to be used in the description of the embodiments will be briefly described below. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

On one aspect, the present disclosure provides a sensing lamp, including a light source 101 and a sense-drive circuit for providing a switching signal to the light source 101. A structure of the sense-drive circuit is illustrated in FIG. 1, including a sensing module 102 configured to sense a trigger signal and generate a switching signal (control signal) according to the trigger signal, a sensing power supply module configured to supply the sensing module 102 with electrical power, and an output module configured to provide a driving signal to the light source according to the control signal.

As can be seen from the above, the sensing lamp includes a light source and a sense-drive circuit for providing a driving signal to the light source. The sense-drive circuit includes a sensing module, a sensing power supply module and an output module. The sensing power supply module is connected with the sensing module, the sensing module is connected with the output module, and the output module is connected with the light source. The sensing module is configured to sense a trigger signal and generate a control signal according to the trigger signal, the output module is configured to provide a driving signal to the light source according to the control signal, and the sensing power supply module is configured to supply the sensing module with electrical power. The sensing lamp can achieve induction lighting under the trigger signal, and provides higher efficiency and stable operation. Further, the sensing power supply module includes a first capacitor C2, a voltage regulator tube D1 and a first resistor R4-R7. The first capacitor C2 and the voltage regulator tube D1 are disposed in parallel; a parallel circuit of the first capacitor C2 and the voltage regulator tube D1 is disposed in series with the first resistor R4-R7. The sensing module 102 at least includes a positive voltage terminal, a reference voltage terminal and a negative voltage terminal, wherein the negative voltage terminal is connected with a grounding terminal. The first resistor R4-R7 is connected with the light source 101. The parallel circuit of the first capacitor C2 and the voltage regulator tube D1 has one end connected with the positive voltage terminal of the sensing module 102, and the other end connected with the grounding terminal.

As can be seen from the above, in the sensing lamp according to the present embodiment of the present disclosure, a voltage of the power supply output terminal can be controlled to a preset value by appropriately designing an output voltage, the first resistor, the first voltage regulator tube and the first capacitor of the sensing module; at the same time, a stabilized voltage of the voltage regulator tube is selected to be consistent with the preset voltage so as to ensure the stability of the voltage; in this way, the sensing lamp achieves efficient and stable working state. The voltages between voltage input terminals of the sensing module are controlled within a predetermined range by adjusting a resistance of the first resistor and a capacitance of the first capacitor, and the voltage regulator tube is employed to prevent a voltage between the voltage terminals from exceeding the preset voltage and damaging the sensing module, which is both simple and convenient without interfering with the sensing module because the outputted direct current has no ripple wave.

In an embodiment of the present disclosure, the sensing module 102 is a microwave sensing module for sensing a microwave of a human body or an animal body, and the trigger signal is a microwave signal.

Sensing power supply modules in the related art are usually achieved by magnetic elements such as transformers or voltage dividers, which are not only expensive but also prone to generate interference and cause false triggering of the sensing module. As a contrast, the sensing power supply module provided by the embodiment of the present disclosure is based on simpler principle, more convenient to produce, and outputs direct current having no ripple wave, which will not interference with the sensing module.

In some embodiments of the present disclosure, still referring to FIG. 1, the first resistor is includes four resistors connected in series, which are R4, R5, R6 and R7, respectively. Through practical application, it is found that a better voltage dividing effect can be achieved by using resistors with a same resistance or different resistances, as compared with using only one resistor, given the same resistance. More specifically, the first capacitor C2 is a ceramic capacitor, and the voltage regulator tube D1 is a voltage regulator tube of 24V. With suitable design, a voltage between a positive voltage output terminal V+ and a negative voltage output terminal V− of the sensing module can be controlled to about 24V, and the voltage regulator tube D1 of 24V can be employed to prevent the voltage between the terminals V+ and V− from exceeding 24V and damaging the sensing module.

In other embodiments of the present disclosure, the first resistor includes at least one resistor.

In other embodiments of the present disclosure, still referring to FIG. 1, the sense-drive circuit further includes a protection module. The protection module is disposed between the light source 101 and the sense-drive circuit in series therewith, for protecting the sense-drive circuit. The protection module includes a first diode D0 and a second capacitor C0 disposed in series with the first diode D0, wherein the first diode D0 is connected with the light source 101, and the second capacitor C0 is connected with the sensing power supply module.

Sensing lamps in the related art usually adopt transient voltage suppressor (TVS) diodes or varistors as protection modules, in which a malfunction of the TVS diode may result in a short circuit or a broken fuse, and a failure of the varistor may lead to fire due to explosion thereof. As a contrast, in the sensing lamp provided by the embodiment of the present disclosure, the driving circuit plays a role of anti-surge function through the protection module, and the protection module will not cause adverse reaction to the sensing lamp in case of failure.

In some embodiments of the present disclosure, still referring to FIG. 1, the output module includes a metal-oxide-semiconductor field effect transistor (MOSFET) 103, wherein a first electrode and a second electrode of the MOSFET 103 are connected with the light source, respectively, and a gate electrode of the MOSFET 103 is connected with the reference voltage terminal of the sensing module.

For example, the first electrode and the second electrode of the MOSFET 103 are connected with the light source 101 through a constant current module. The output module further includes a first protection capacitor C3 disposed in parallel with the MOSFET 103.

In some embodiments of the present disclosure, still referring to FIG. 1, the sensing driving module further including a constant current module, wherein the constant current module further includes a first constant current chip 104 and a second constant current chip 105; voltage output pins of the constant current chips are connected with the light source; signal input pins of the constant current chips are connected with the parallel circuit of the voltage regulator tube D1 and the first capacitor C2, and are connected with the MOSFET 103. The constant current chips can stabilize the current and reduce the ripple wave.

In some embodiments of the present disclosure, still referring to FIG. 1, a fourth resistor R8 is disposed, in series, between the first electrode of the MOSFET 103 and a third end of the first constant current chip 104; and the fourth resistor R8 and a fifth resistor R9 are disposed, in series, between the second electrode of the MOSFET and a third end of the second constant current chip 105.

The sensing module can change a lighting state of the light source by providing a signal to the output module to adjust a magnitude of output current of the output module. In an embodiment of the present disclosure, the lighting state of the light source includes at least a first brightness and a second brightness.

In some embodiments of the present disclosure, still referring to FIG. 1, a third resistor 106 is disposed, in series, between the reference voltage terminal of the sensing module 102 and the gate electrode of the MOSFET 103.

For example, the third resistor may be a single resistor, or may be comprised of a plurality of resistors disposed between the reference voltage terminal V0 of the sensing module and the gate electrode of the MOSFET 103, respectively. For example, a resistance of the third resistor is ranged from 100K to 1000K.

With the third resistor disposed between the sensing module and the MOSFET 103A, a shorter buffer time can be provided when changing the current magnitude of the entire circuit to switch the light source between a first brightness state and a second brightness state, in order to implant a transitional brightness state between the first brightness state and the second brightness state and to prevent the light source from suddenly changing from the first brightness state to the second brightness state; which provides a vision adaptation process for the user when the sensing lamp switches from the first brightness state to the second brightness state.

In some embodiments of the present disclosure, still referring to FIG. 1, the light source includes a light-emitting diode (LED). In the embodiment as illustrated in FIG. 1, the light source includes four LEDs.

In some embodiments of the present disclosure, still referring to FIG. 1, the sense-drive circuit further includes a rectifier filter module. The rectifier filter module further includes a rectifier bridge 108, wherein the rectifier bridge 108 is composed of four diodes and is provided with four connection ports, in which a first connection port 1081 and a second connection port 1082 are respectively connected with a power supply 107, and a third connection port 1083 and a fourth connection port 1084 are respectively connected with the light source and the grounding terminal. For example, the power supply 107 is an alternating current (DC) power source of 220V-240V.

In some embodiments of the present disclosure, the rectifier filter module further includes a sixth resistor. The sixth resistor is composed of at least one resistor, wherein one end of the sixth resistor is connected with the light source, and the other end of the sixth resistor is connected with the grounding terminal. In an embodiment as illustrated in FIG. 1, the sixth resistor is composed of capacitors R1 and R2 which are disposed in parallel.

In some embodiments of the present disclosure, still referring to FIG. 1, a circuit portion of the sensing lamp further includes a second protection capacitor C4 which is disposed in parallel with the light source 101.

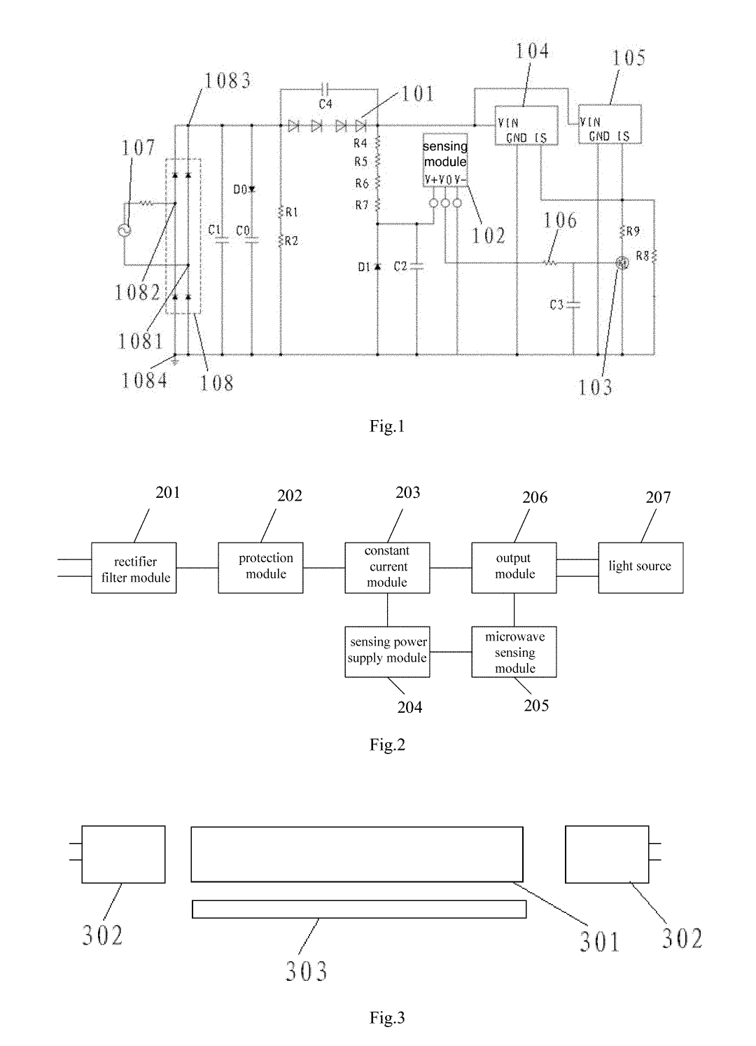

In an embodiment of the present disclosure, as illustrated in FIG. 2, the sensing lamp includes a rectifier filter module 201, a protection module 202, a constant current module 203, a power supply module 204, a microwave sensing module 205, an output module 206, and a light source 207. One end of the rectifier filter module 201 is connected with the power supply. The rectifier filter module 201, the protection module 202, the constant current module 203, the output module 206, and the light source 207 are connected successively in this order. One end of the power supply module 204 is connected with the constant current module 203, and the other end of the power supply module 204 is connected with one end of the microwave sensing module 205. The other end of the microwave sensing module 205 is connected with the output module 206. The constant current module 203 enables the microwave sensing module 205 to obtain a stable operating voltage. Through the constant current module 203 and the sensing power supply module 204, the microwave sensing module 205 can control the output voltage of the output module 204 according an external microwave signal as sensed, so that a brightness of the light source can be changed with the microwave in the external environment. When a human body enters a sensing range of the sensing lamp, the microwave sensing module 205 senses microwaves and outputs a high level signal such that the output module 204 is turned on and a voltage is inputted to the light source 207 to allow the light source 207 to be switched from a first brightness to a second brightness, wherein the second brightness is higher than the first brightness.

The sensing lamps provided in the preceding embodiments can supply the microwave sensing module 205 with a stable operating voltage through the constant current module 203, and adjust the output module 204 through the microwave sensing module 205 and associated peripheral circuits, so that a power and a brightness of the light source 207 can be switched in a softer manner to provide people with a vision adaption process. The solution of the entire sensing lamp is based on simpler principle, involves lower cost, and has a strong anti-surge capability without rendering any electro magnetic compatibility (EMC) problem.

Regarding specific structures of the above circuit portion in the preceding embodiments, reference can still be made to FIG. 1. The rectifier filter module includes a rectifier bridge and a film capacitor C1, and functions to convert the AC power into unidirectional DC power and reduce the ripple wave. The protection module includes a first diode D0 and a second capacitor C0, wherein the second capacitor C0 is a ceramic capacitor, and the protection module provides anti-surge function. The constant current module can stabilize the driving signal provided by the output module, and uses two constant current chips as its core. The two constant current chips are respectively a first constant current chip and a second constant current chip, each of the chips is provided with a signal input pin IS, a grounding pin GND and a voltage output pin VIN, wherein the grounding pin GND is connected with a parallel circuit of the voltage regulator tube D1 and the first capacitor C2; the signal input pin IS is connected with the first or second electrode of the MOSFET; and the voltage output pin VIN is connected with the light source 101. The constant current module of the embodiment of the present disclosure can absorb the voltage above the LED load voltage, so as to ensure a constant current output of the circuit. The output current is smooth and steady, with little ripple wave. The output module is composed of a fourth resistor R8, a fifth resistor R9 and a MOSFET, in which the output current can be changed by changing the resistance of the fourth resistor R8 and the fifth resistor R9. The sensing power supply module includes a first resistor R4, R5, R6, and R7, a voltage regulator tube D1 of 24V, and a ceramic capacitor C2, which can maintain a voltage between the V+ terminal and the V− terminal of the sensing module 101 at about 24V so that the sensing module 101 can run normally; moreover, the voltage regulator tube D1 of 24V is disposed to prevent a voltage between the V+ terminal and the V− terminal from exceeding 24V and damaging the sensing module 101. The sensing module 101 can control the MOSFET 103 to operate or not to operate by outputting a high level or a low level. A high level is outputted when the sensing module 101 is triggered by a microwave so as to enable the MOSFET 103, in which the output current of the circuit is large and the light source 101 illuminates at a second brightness; by contrary, when there is no microwave triggering the sensing module 101, the MOSFET 103 doesn't operate, in which the output current of the circuit is small, and the light source 101 illuminates at a first brightness; wherein the second brightness is larger than the first brightness. The light source 101 includes a LED having a rated voltage of about 240 V and a protection capacitor C4. The protection capacitor C4 are disposed in parallel with both ends of the LED, so as to prevent a high voltage of an instantaneous pulse of the circuit from damaging the LED, and also to provide filtering effect.

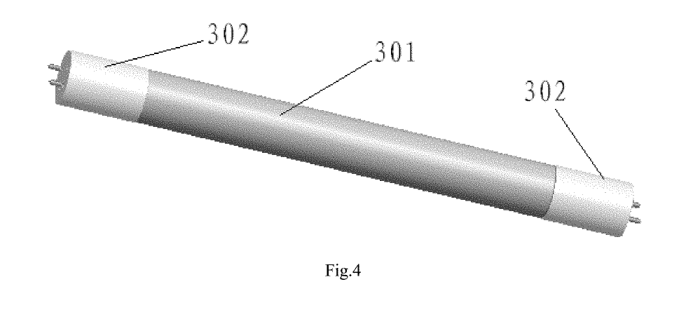

In some embodiments of the present disclosure, referring to FIG. 3 and FIG. 4, FIG. 3 illustrates a schematically exploded view of a sensing lamp. The sensing lamp further includes a glass tube 301 in which the light source is disposed and a plug 302 provided at both ends of the glass tube, wherein the sensing module is connected with the plug 302.

In an embodiment of the present disclosure, the sensing module is disposed in the plug at one end of the glass tube 301, and other components of the sense-drive circuit are disposed in the plug at the other end of the glass tube 301. The sensing module adjusts the brightness of the light source by controlling the voltage output state of the sense-drive circuit through sensing the presence or absence of a moving object within the environment. With the glass tube 301, the sensing lamp can illuminate uniformly, be easy to use, and suitable for plenty of places such as underground garage, automated factories, warehouses, elevators and balconies with safety and energy saved. The plug 302 can be made of plastic or other insulating materials.

In some embodiments of the present disclosure, still referring to FIG. 3, the sensing lamp further includes a flexible printed circuit board (FPCB) 303. The light source is provided on the FPCB 303. In an assembled state, the FPCB 303 is attached to an inner side of the glass tube 301.

By attaching the light source to the FPCB, a thermal resistance is reduced. Also, by attaching the light source and the FPCB to inner bottom of the lamp, the heat dissipation is felicitated. FPCB can be attached to an inner wall of the glass tube through a thermal adhesive with high thermal conductivity, and the plugs at both ends of the glass tube are connected with the glass tube integrally through a silica gel.

In some embodiments of the present disclosure, still referring to FIG. 3, the light source includes a plurality of LEDs, wherein the LEDs are evenly distributed on the FPCB 303.

In some embodiments of the present disclosure, an interior of the glass tube 301 is provided with diffusion powder.

Moreover, the present disclosure further provides a driving method of a sensing lamp, including: sensing a microwave signal of an environment; and upon sensing the microwave signal, sending an electric signal to the light source so that a brightness of the light source is changed from a first brightness to a second brightness, wherein the second brightness is higher than a first brightness.

The sensing lamps provided by the embodiments of the present disclosure can realize switching from the first brightness to the second brightness, and improve the user's comfort index, in which the sensing distance is longer, the response time is shorter, the sensitivity is better and the response is rapid.

It will be apparent to those skilled in the art that various changes and modifications may be made to this disclosure without departing from the spirit and scope of the present disclosure. Thus, it is intended that the present disclosure encompasses such modifications and variations, if such modifications and variations are within the scope of the present disclosure claims and equivalents thereof.

What is claimed is:

1. A sensing lamp, comprising a light source and a sense-drive circuit configured to provide a driving signal to the light source, wherein
the sense-drive circuit comprises a sensing module, a sensing power supply module and an output module; the sensing power supply module is connected with the sensing module, the sensing module is connected with the output module, and the output module is connected with the light source;
the sensing module is configured to sense a trigger signal and generate a control signal according to the trigger signal;
the output module is configured to provide a driving signal to the light source according to the control signal; and
the sensing power supply module is configured to supply the sensing module with electrical power.

2. The sensing lamp according to claim 1, wherein
the sensing power supply module comprises a first capacitor, a voltage regulator tube and a first resistor, wherein the first capacitor and the voltage regulator tube are disposed in parallel;
the sensing module comprises a positive voltage terminal, a negative voltage terminal and a reference voltage terminal, wherein the negative voltage terminal is connected with a grounding terminal;
the first resistor is connected with the light source; and
a parallel circuit of the first capacitor and the voltage regulator tube has one end respectively connected with the positive voltage terminal of the sensing module and the first resistor, and the other end connected with the grounding terminal.

3. The sensing lamp according to claim 2, wherein the first resistor comprises four resistors connected in series.

4. The sensing lamp according to claim 1, wherein the sense-drive circuit further comprises a protection module;
the protection module is disposed, in series, between the light source and the sense-drive circuit, and the protection module is configured to protect the sense-drive circuit; and
the protection module comprises a first diode and a second capacitor disposed in series with the first diode, wherein the first diode is connected with the light source, and the second capacitor is connected with the sensing power supply module.

5. The sensing lamp according to claim 1, wherein the output module comprises a metal-oxide-semiconductor field effect transistor (MOSFET);
a first electrode and a second electrode of the MOSFET are connected with the light source, and a gate electrode of the MOSFET is connected with the reference voltage terminal of the sensing module.

6. The sensing lamp according to claim 5, wherein the output module further comprises a third resistor,
the third resistor is disposed between the reference voltage terminal of the sensing module and the gate electrode of the MOSFET.

7. The sensing lamp according to claim 5, wherein the output module further comprises a first protection capacitor,
the first protection capacitor is disposed in parallel with the MOSFET.

8. The sensing lamp according to claim 1, wherein the light source comprises a light-emitting diode (LED).

9. The sensing lamp according to claim 5, wherein the sense-drive circuit further comprises a constant current module configured to stabilize the driving signal provided by the output module;
the constant current module comprises a first constant current chip and a second constant current chip, wherein each of the first constant current chip and the second constant current chip has a first end connected with the light source, a second end connected with a grounding terminal, and a third end connected with a first electrode or a second electrode of the MOSFET.

10. The sensing lamp according to claim 9, wherein the output module further comprises a fourth resistor and a fifth resistor;
the fourth resistor is disposed between the first electrode of the MOSFET and the third end of the first constant current chip; and
the fifth resistor is disposed between the second electrode of the MOSFET and the third end of the second constant current chip.

11. The sensing lamp according to claim 1, wherein the sense-drive circuit further comprises a rectifier filter module,
the rectifier filter module comprises a rectifier bridge, the rectifier bridge comprises four diodes and is provided with four connection ports, wherein a first connection port and a second connection port are respectively connected with a positive terminal and a negative terminal of a power supply, and a third connection port and a fourth connection port are respectively connected with the light source and a grounding terminal.

12. The sensing lamp according to claim 11, wherein the rectifier filter module further comprises a sixth resistor,
the sixth resistor comprises at least one resistor, wherein one end of the sixth resistor is connected with the light source, and the other end of the sixth resistor is connected with the grounding terminal.

13. The sensing lamp according to claim 1, further comprising a second protection capacitor disposed in parallel with the light source.

14. The sensing lamp according to claim 1, further comprising a glass tube in which the light source is disposed and a plug provided at both ends of the glass tube, wherein the sensing module is connected with the plug.

15. The sensing lamp according to claim 14, further comprising a flexible printed circuit board (FPCB), wherein
the light source is disposed on the FPCB, and the FPCB is attached to an inner side of the glass tube.

16. The sensing lamp according to claim 15, wherein the light source comprises a plurality of light-emitting diodes (LEDs), and the LEDs are evenly distributed on the FPCB.

17. The sensing lamp according to claim 14, wherein an interior of the glass tube is provided with diffusion powder.

18. The sensing lamp according to claim 1, wherein the trigger signal is a microwave signal.

19. The sensing lamp according to claim 1, wherein the sensing module is a microwave sensing module configured to sense a microwave of a human body or an animal body.

20. A driving method of a sensing lamp, comprising:
sensing a microwave signal in an environment; and
upon sensing the microwave signal, sending an electric signal to a light source so that a brightness of the light source is switched from a first brightness to a second brightness, wherein the second brightness is higher than the first brightness.
